(19) United States
(12) Patent Application Publication
(10) Pub. No.: US 2026/0099896 A1
(43) Pub. Date: Apr. 9, 2026

(54) METHOD FOR TRAINING NEURAL NETWORK TO OBFUSCATE FACIAL IMAGE AND ELECTRONIC DEVICE PERFORMING THE SAME

(71) Applicants: 42dot Inc., Gyeonggi-do (KR); Korea University Research and Business Foundation, Seoul (KR)

(72) Inventors: Seonggyun Jeong, Gyeonggi-do (KR); Seung-Won Yang, Gyeonggi-do (KR); Chang-Su Kim, Seoul (KR); Jintae Kim, Gyeonggi-do (KR)

(73) Assignees: 42dot Inc., Gyeonggi-do (KR); Korea University Research and Business Foundation, Seoul (KR)

(21) Appl. No.: 19/319,630

(22) Filed: Sep. 4, 2025

(30) Foreign Application Priority Data
Sep. 6, 2024 (KR) 10-2024-0121772

(51) Int. Cl. G06T 3/4046; G06T 3/18; G06T 3/4038

(52) U.S. Cl. CPC G06T 3/4046; G06T 3/18; G06T 3/4038

(57) ABSTRACT

A method of training a neural network configured to obfuscate a facial image and an electronic device for performing the method are provided. The method includes obtaining, based on an input facial image, an output facial image in which the input facial image is obfuscated, extracting, based on the input facial image, a feature of the input facial image for reconstructing identification information included in the input facial image from the output facial image, extracting, based on the output facial image, a feature of the output facial image corresponding to the feature of the input facial image, and training the neural network based on a difference between the feature of the input facial image and the feature of the output facial image.

### CROSS-REFERENCE TO RELATED APPLICATION

This application claims the benefit of Korean Patent Application No. 10-2024-0121772, filed on Sep. 6, 2024, in the Korean Intellectual Property Office, the entire disclosure of which is incorporated herein by reference for all purposes.

### BACKGROUND

### 1. Field of the Invention

One or more embodiments relate to a method of training a neural network to obfuscate a facial image and an electronic device for performing the method.

### 2. Description of the Related Art

Image obfuscation may be a technique of intentionally distorting or transforming an image to make the original image unrecognizable. Obfuscated images may be evaluated specifically by two major indicators. One indicator is human indecipherability (HI), which may represent how unrecognizable the obfuscated image is to humans. The other indicator is machine decipherability (MD), which may represent how effectively the obfuscated image can be deciphered by a machine (e.g., a facial recognition algorithm).

Image obfuscation techniques may be used to conceal specific parts of an image or to protect an entire image and applied in various fields for information protection, privacy protection, or data security.

The above description is information the inventor(s) acquired during the course of conceiving the present disclosure, or already possessed at the time, and is not necessarily art publicly known before the present application was filed.

### SUMMARY

An embodiment provides a technique for training a neural network to achieve a balance between the degree of obfuscation of an input facial image and the degree of reconstruction to the input facial image.

However, the technical goals are not limited to those described above, and other technical goals may also exist.

According to an aspect, there is provided a method of training a neural network configured to obfuscate a facial image including obtaining, based on an input facial image, an output facial image in which the input facial image is obfuscated, extracting, based on the input facial image, a feature of the input facial image for reconstructing identification information included in the input facial image from the output facial image, extracting, based on the output facial image, a feature of the output facial image corresponding to the feature of the input facial image, and training the neural network based on a difference between the feature of the input facial image and the feature of the output facial image.

The obtaining of the output facial image may include generating the output facial image by inputting the input facial image to the neural network.

The generating of the output facial image may include performing an averaging transformation on the input facial image, rearranging pixels of the input facial image, on which the averaging transformation has been performed, by warping the input facial image on which the averaging transformation has been performed, adding noise to the input facial image whose pixels have been rearranged, and generating the output facial image by adjusting a color value of the input facial image to which the noise has been added.

The averaging transformation may include a mosaic transformation and a transformation that adjusts pixels along one axis of an image to an average value of the pixels.

The noise may include sinusoid-based noise, checkerboard-based noise, and speckle-based noise.

The training of the neural network may include updating parameters of the neural network through a backpropagation refinement scheme, based on a difference between the feature of the input facial image and the feature of the output facial image. The parameters of the neural network relate to obfuscating the input facial image.

The backpropagation refinement scheme may include repeatedly performing a forward propagation process and a backpropagation process to determine the parameters of the neural network, such that a trade-off is achieved between an obfuscation degree of the output facial image and a reconstruction degree of the identification information from the output facial image. The forward propagation process may include obtaining the output facial image, extracting the feature of the input facial image, and extracting the feature of the output facial image. The backpropagation process may include updating the parameters of the neural network.

The updating of the parameters of the neural network may include calculating a distance between the feature of the input facial image and the feature of the output facial image and changing the parameters of the neural network such that the distance is minimized.

The updating of the parameters of the neural network may include calculating a cosine similarity between the feature of the input facial image and the feature of the output facial image and changing the parameters of the neural network such that the cosine similarity is maximized.

The updating of the parameters of the neural network may include changing the parameters of the neural network such that the parameters of the neural network do not exceed a preset threshold value.

According to an aspect, there is provided an electronic device for obfuscating a facial image including a processor and memory storing instructions. The instructions, when executed by the processor, cause the electronic device to obtain, based on an input facial image, an output facial image in which the input facial image is obfuscated through a neural network. The neural network is trained by a method according to any one of claims 1 to 10.

According to an aspect, there is provided an electronic device for training a neural network configured to obfuscate a facial image including a processor and memory storing instructions. The instructions, when executed by the processor, cause the electronic device to obtain, based on an input facial image, an output facial image in which the input facial image is obfuscated, extract, based on the input facial image, a feature of the input facial image for reconstructing identification information included in the input facial image from the output facial image, extract, based on the output facial image, a feature of the output facial image corresponding to the feature of the input facial image, and train the neural network based on a difference between the feature of the input facial image and the feature of the output facial image.

The instructions, when executed by the processor, may cause the electronic device to generate the output facial image by inputting the input facial image to the neural network.

The instructions, when executed by the processor, may cause the electronic device to perform an averaging transformation on the input facial image, rearrange pixels of the input facial image, on which the averaging transformation has been performed, by warping the input facial image on which the averaging transformation has been performed, add noise to the input facial image whose pixels have been rearranged, and generate the output facial image by adjusting a color value of the input facial image to which the noise has been added.

The averaging transformation may include a mosaic transformation and a transformation that adjusts pixels along one axis of an image to an average value of the pixels.

The instructions, when executed by the processor, may cause the electronic device to update parameters of the neural network through a backpropagation refinement scheme, based on a difference between the feature of the input facial image and the feature of the output facial image. The parameters of the neural network relate to obfuscating the input facial image.

The backpropagation refinement scheme may include repeatedly performing a forward propagation process and a backpropagation process to determine the parameters of the neural network, such that a trade-off is achieved between an obfuscation degree of the output facial image and a reconstruction degree of the identification information from the output facial image. The forward propagation process may include obtaining the output facial image, extracting the feature of the input facial image, and extracting the feature of the output facial image. The backpropagation process may include updating the parameters of the neural network.

The instructions, when executed by the processor, may cause the electronic device to calculate a distance between the feature of the input facial image and the feature of the output facial image and change the parameters of the neural network such that the distance is minimized.

The instructions, when executed by the processor, may cause the electronic device to calculate a cosine similarity between the feature of the input facial image and the feature of the output facial image and change the parameters of the neural network such that the cosine similarity is maximized.

The instructions, when executed by the processor, may cause the electronic device to change the parameters of the neural network such that the parameters of the neural network do not exceed a preset threshold value.

### BRIEF DESCRIPTION OF THE DRAWINGS

FIG. 1 illustrates an example of an electronic device configured to obfuscate a facial image according to an embodiment.

FIG. 2 illustrates a schematic block diagram of the electronic device illustrated in FIG. 1.

FIG. 3 is a diagram illustrating a method of training a neural network using a backpropagation refinement scheme according to an embodiment.

FIG. 4 illustrates an example flowchart of a method of training a neural network according to an embodiment.

### DETAILED DESCRIPTION

The following detailed structural or functional description is provided as an example only and various alterations and modifications may be made to the embodiments. Accordingly, the embodiments are not to be construed as limited to the disclosure and should be understood to include all changes, equivalents, or replacements within the idea and the technical scope of the disclosure.

Terms, such as “first”, “second”, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

A module in the present disclosure may be hardware that may perform functions and operations according to the disclosure, may be computer program code that may perform a predetermined function and operation, or may be an electronic recording medium on which computer program code that may perform a predetermined function and operation is mounted, for example, a processor or a microprocessor.

In other words, the module may be hardware for performing the idea and the technical scope of the disclosure, a functional and/or structural combination of software performing the hardware.

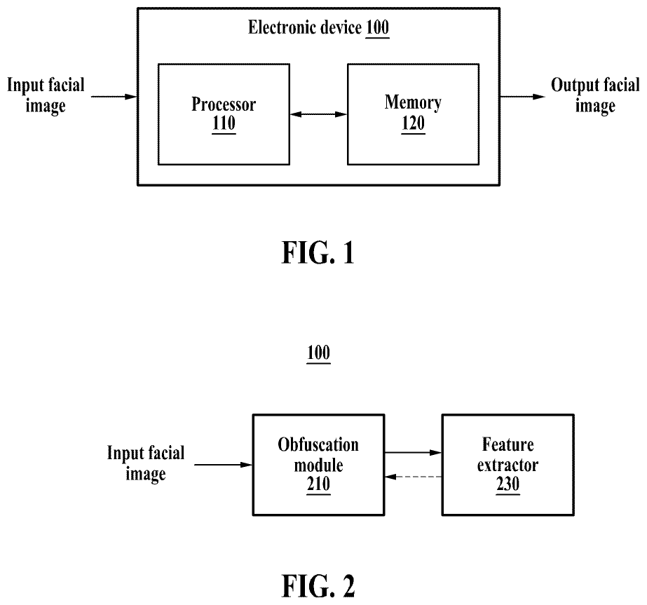

FIG. 1 illustrates an example of an electronic device configured to obfuscate a facial image according to an embodiment.

Referring to FIG. 1, an electronic device 100 may train a neural network (or a neural network model). In addition, the electronic device 100 may perform inference (e.g., obfuscation of a facial image) using the trained neural network.

A neural network (or an artificial neural network) may include a statistical learning algorithm that mimics biological neural systems in the fields of machine learning and cognitive science. A neural network may refer to an overall model including artificial neurons (nodes) connected via synapses, which adjust the strength of the connections through training to acquire problem-solving capabilities.

Neurons of a neural network may include weights and biases. The neural network may include one or more layers including one or more neurons or nodes. The neural network may infer an output from an arbitrary input by adjusting the weights of the neurons through training.

A neural network may include a deep neural network (DNN). The neural network may include various types of architectures such as a convolutional neural network (CNN), a recurrent neural network (RNN), a perceptron, a multilayer perceptron (MLP), a feedforward network (FF), a radial basis function network (RBF), a deep feedforward network (DFF), a long short-term memory (LSTM) network, a gated recurrent unit (GRU), an autoencoder (AE), a variational autoencoder (VAE), a denoising autoencoder (DAE), a sparse autoencoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural Turing machine (NTM), a capsule network (CN), a Kohonen network (KN), and an attention network (AN).

The electronic device 100 may be implemented on an embedded system with limited hardware resources by using a lightweight neural network model. The neural network training device 10 may perform both training and inference on-device.

The electronic device 100 may be implemented as a printed circuit board (PCB) such as a motherboard, an integrated circuit (IC), or a system on chip (SoC). For example, the electronic device 100 may be implemented as an application processor.

In addition, the electronic device 100 may be implemented in a personal computer (PC), a data server, or a portable device.

The portable device may be implemented as a laptop computer, mobile phone, smart phone, tablet PC, mobile internet device (MID), personal digital assistant (PDA), enterprise digital assistant (EDA), digital still camera, digital video camera, portable multimedia player (PMP), personal navigation device (PND) or portable navigation device, handheld game console, e-book, or smart device. The smart device may be implemented as a smart watch, smart band, or smart ring.

The electronic device 100 may train a neural network by processing parameters (or weights) of a neural network model. The electronic device 100 may generate a lightweight neural network model by processing parameters of a neural network model trained with full precision.

The electronic device 100 may obtain new parameters by processing parameters that change during the training of a neural network model and retrain the neural network model based on the new parameters.

The electronic device 100, based on an input facial image, may obtain an output facial image in which the input facial image is obfuscated.

The electronic device 100 may extract, based on the input facial image, a feature of the input facial image for reconstructing identification information included in the input facial image from the output facial image. The electronic device 100 may extract, based on the output facial image, a feature of the output facial image corresponding to the feature of the input facial image.

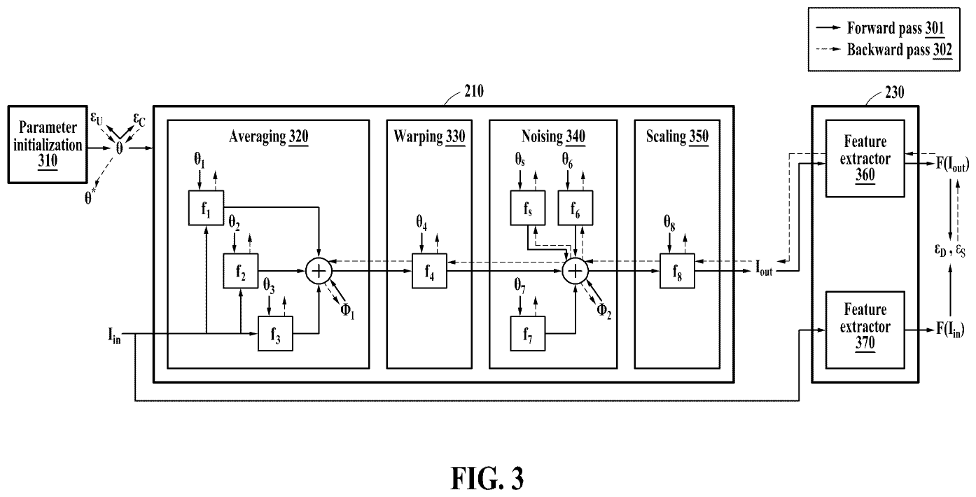

The electronic device 100 may train the neural network based on the difference between the feature of the input facial image and that of the output facial image. The training may be performed through a backpropagation refinement scheme. This training process will be described in greater detail with reference to FIGS. 2 and 3.

The electronic device 100 may include a processor 110 and memory 120.

The processor 110 may process data stored in the memory 120. The processor 110 may execute computer-readable code (e.g., software) and instructions stored in the memory 120.

The processor 110 may be a hardware-implemented data processing device with a physically structured circuit to execute desired operations. For example, the desired operations may include code or instructions included in a program.

For example, the data processing device implemented by hardware may include a microprocessor, a central processing unit (CPU), a processor core, a multi-core processor, a multiprocessor, an application-specific integrated circuit (ASIC), and a field-programmable gate array (FPGA).

The memory 120 may store a neural network model or parameters of the neural network model. The memory 120 may store instructions (or programs) executable by a processor. For example, the instructions may include instructions for executing operations of the processor and/or operations of each component of the processor.

The memory 120 may be implemented in a volatile or non-volatile memory device.

A volatile memory device may be implemented as dynamic random-access memory (DRAM), static random-access memory (SRAM), thyristor RAM (T-RAM), zero capacitor RAM (Z-RAM), or Twin Transistor RAM (TTRAM).

A non-volatile memory device may be implemented as electrically erasable programmable read-only memory (EEPROM), flash memory, magnetic RAM (MRAM), spin-transfer torque MRAM (STT-MRAM), conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), holographic memory, molecular electronic memory device, or insulator resistance change memory.

The processor 110 may cause the electronic device 100 to perform one or more operations by executing code and/or instructions stored in the memory 120. Hereinafter, operations performed by the electronic device 100 are described in detail with reference to FIGS. 2 to 4.

FIG. 2 illustrates a schematic block diagram of the electronic device illustrated in FIG. 1.

Referring to FIG. 2, the electronic device 100 may include an obfuscation module 210 and a feature extractor 230. The obfuscation module 210 and the feature extractor 230 may be implemented as separate neural networks or as a single integrated neural network. Hereinafter, for convenience of explanation, it is assumed that the obfuscation module 210 and the feature extractor 230 are implemented as separate neural networks.

The obfuscation module 210 may generate an output facial image, in which an input facial image is obfuscated, based on the input facial image. The obfuscation module 210 may perform various transformations (e.g., an averaging transformation, warping, noise addition, and/or color value adjustment) on the input facial image sequentially or in parallel to generate the output facial image. These various transformations may be performed in different layers of the obfuscation module 210, and the degree of transformation may be determined based on parameters of the respective layers. The parameters of the layers may relate to the obfuscation of the input facial image.

Generally, various transformations are performed such that the output facial image is not easily recognized by humans. Accordingly, the degree of transformation may be set to a high level by default. If the degree of transformation is set high, the obfuscation degree may increase; however, it may become difficult to reconstruct the input facial image from the output facial image. Therefore, it may be necessary to set the parameters of the layers of the obfuscation module 210 in a manner that balances the obfuscation degree of the output facial image and the reconstruction degree of the input facial image.

The difference (or similarity) between the feature of the input facial image and the feature of the output facial image may be used to reconstruct the input facial image from the output facial image. Reconstructing the input facial image from the output facial image may include reconstructing identification information included in the input facial image. As the difference between the feature of the input facial image and the feature of the output facial image decreases, it may become easier to reconstruct the identification information included in the input facial image from the output facial image. For example, when the input facial image is transformed through the obfuscation module 210, the smaller the difference between the feature of the input facial image and the feature of the transformed image (e.g., the output facial image), the higher the reconstructability (e.g., the degree to which identification information included in the input facial image may be reconstructed from the output facial image) may be. To achieve this, the feature of the input facial image and the feature of the output facial image may be extracted through the feature extractor 230, and the parameters of the layers of the obfuscation module 210 may be trained such that the difference between the two features is minimized.

The feature extractor 230 may extract a feature of a facial image based on the facial image (e.g., an input facial image and/or an output facial image). For example, the feature extractor 230 may extract a feature of the input facial image for reconstructing identification information included in the input facial image from the output facial image. The feature extractor 230 may extract a feature of the output facial image corresponding to the feature of the input facial image, based on the output facial image.

The feature of a facial image extracted by the feature extractor 230 may be determined based on the information to be reconstructed from the input facial image (e.g., identification information of the input facial image). For example, if gender information of the input facial image is to be reconstructed from the output facial image, features related to the gender of the input facial image may be extracted by the feature extractor 230.

A reconstructability (or reconstruction degree) of the input facial image from the output facial image generated by the obfuscation module 210 may be increased by training parameters of layers of the obfuscation module 210 based on a difference between a feature of the input facial image and a feature of the output facial image.

The electronic device 100 may update parameters of layers (e.g., layers performing various transformations) of the obfuscation module 210 such that the parameters achieve a trade-off between an obfuscation degree and a reconstruction degree. As the obfuscation degree increases, the reconstruction degree tends to decrease, and vice versa. Accordingly, it may be important that the parameters have values that balance the trade-off between the obfuscation degree and the reconstruction degree. The parameters of the layers of the obfuscation module 210 may be updated through training using a backpropagation refinement scheme, which will be described in detail with reference to FIG. 3.

FIG. 3 is a diagram illustrating a method of training a neural network using a backpropagation refinement scheme according to an embodiment.

Referring to FIG. 3, the electronic device 100 may include a parameter initialization module 310, the obfuscation module 210, and the feature extractor 230.

The obfuscation module 210 may perform various transformations (e.g., an averaging transformation, warping, noise addition, and/or color value adjustment) on an input facial image Iᵢₙ. The various transformations may be performed by a plurality of layers included in the obfuscation module 210. Hereinafter, the transformations performed by each of the layers will be described.

The obfuscation module 210 may include an averaging layer 320, a warping layer 330, a noising layer 340, and a scaling layer 350.

The averaging layer 320 may perform an averaging transformation (or mean transformation) on the input facial image Iᵢₙ. The averaging transformation may be a transformation that removes high-frequency information and retains low-frequency information from an input facial image, thereby removing details of the image. The averaging transformation may include a mosaic transformation f₁ and a transformation (e.g., a horizontal mean transformation f₂ and/or a vertical mean transformation f₃) that adjusts the pixels along one axis of the image to the average of those pixels.

The mosaic transformation f₁ may be a transformation that divides the input facial image Iᵢₙ into a plurality of blocks and adjusts the pixel values of each block to the average of the pixel values within each block. For example, the averaging layer 320 may divide the image into M×N blocks and calculate the average pixel value of each block. The averaging layer 320 may adjust the pixel values of each block to the average value of the pixels within the block. As a result, all pixel values within each M×N block may become identical, thereby removing high-frequency information of the input facial image. The degree of the mosaic transformation f₁ may be determined based on a parameter θ₁ of the averaging layer 320. For example, as the parameter θ₁ increases, the degree of the mosaic transformation may increase, resulting in a higher degree of obfuscation of an output facial image Iₒᵤₜ.

The horizontal mean transformation f₂ may be a transformation that adjusts the pixel values of blocks arranged along the horizontal axis of the input facial image Iᵢₙ to the average of the pixel values within each block. The degree of the horizontal mean transformation f₂ may be determined based on a parameter θ₂ of the averaging layer 320. For example, as the parameter θ₂ increases, the degree of the horizontal mean transformation f₂ may increase, resulting in a higher degree of obfuscation of the output facial image Iₒᵤₜ.

The vertical mean transformation f₃ may be a transformation that adjusts the pixel values of blocks arranged along the vertical axis of the input facial image Iᵢₙ to the average of the pixel values within each block. The degree of the vertical mean transformation f₃ may be determined based on a parameter θ₃ of the averaging layer 320. For example, as the parameter θ₃ increases, the degree of the vertical mean transformation f₃ may increase, resulting in a higher degree of obfuscation of the output facial image Iₒᵤₜ.

The averaging layer 320 may combine an input facial image on which the mosaic transformation f₁, the horizontal mean transformation f₂, and the vertical mean transformation f₃ have been performed. For example, the averaging layer 320 may normalize, using a SoftMax operation, the blocks of the input facial image processed by the mosaic transformation f₁, the horizontal mean transformation f₂, and the vertical mean transformation f₃. Then, the averaging layer 320 may combine the normalized blocks to generate a single overlapped block. The image subjected to the averaging transformation may include a plurality of such overlapped blocks. Specifically, the averaging layer 320 may combine, using Equation 1 below, the input facial image on which the mosaic transformation f₁, the horizontal mean transformation f₂, and the vertical mean transformation f₃ have been performed.

$${B}_{avg}^{c} = {\overline{ϕ}}_{1}^{{}_{c}} \cdot {B}_{1}^{c} + {\overline{ϕ}}_{2}^{{}_{c}} \cdot {B}_{2}^{c} + {\overline{ϕ}}_{3}^{{}_{c}} \cdot {B}_{3}^{c} \qquad [ Equation 1 ]$$

In Equation 1, B₁ denotes a block of an image on which the mosaic transformation f₁ has been performed, B₂ denotes a block of an image on which the horizontal mean transformation f₂ has been performed, and B₃ denotes a block of an image on which the vertical mean transformation f₃ has been performed.

$${\overline{ϕ}}_{1}^{{}_{c}} to {\overline{ϕ}}_{3}^{{}_{c}}$$

denote random parameters for performing a SoftMax operation on corresponding indexed blocks. B_{avg} denotes an overlapped block, and c denotes a red, green, and blue (RGB) channel of the input facial image.

The warping layer 330 may perform a warping transformation (hereinafter, referred to as warping transformation f₄) on an input facial image on which an averaging transformation has been performed to rearrange pixels of the input facial image on which the averaging transformation has been performed. That is, the warping transformation f₄ may include a transformation of geometric features of the image. For example, the warping layer 330 may distort a facial image based on grid points (e.g., intersection points among blocks) within M×N blocks of the image (e.g., an input facial image on which the averaging transformation has been performed by the averaging layer 320). The warping layer 330 may move each grid point by a value determined based on a parameter θ₄ of the warping layer 330. The warping layer 330 may move each grid point by (θ₄×Δ). Here, Δ denotes the size of a block (e.g., the vertical size of the block when moving the grid point vertically or the horizontal size of the block when moving the grid point horizontally). The warping layer 330 may move grid points in a manner that prevents the grid points from overlapping with one another. By doing so, the warping transformation f₄ may cause distortion in the facial image. As the parameter θ₄ increases, the grid points are moved to a greater extent, thereby increasing the degree of the warping transformation f₄, which in turn may increase the obfuscation degree of the output facial image Iₒᵤₜ.

The noising layer 340 may add noise to an input facial image (e.g., the input facial image on which transformations are performed by the averaging layer 320 and the warping layer 330) in which the pixels have been rearranged. By adding the noise, the noising layer 340 may introduce high-frequency components to increase the complexity of the image and may thereby increase the reconstructability of the original image (e.g., the input facial image) from the transformed image.

Noise may include sinusoid-based noise, checkerboard-based noise, and/or speckle-based noise. For example, the noising layer 340 may perform a sinusoid-based noise addition transformation f₅ on a facial image. The noising layer 340 may perform a checkerboard-based noise addition transformation f₆ on the facial image. The noising layer 340 may perform a speckle-based noise addition transformation f₇ on the facial image.

The sinusoid-based noise addition transformation f₅ may be performed based on a parameter θ₅ of the noising layer 340. For example, the noising layer 340 may generate a sinusoid-based noise for each block of a facial image (e.g., the input facial image on which transformations are performed by the averaging layer 320 and the warping layer 330) along an axis, using the parameter θ₅. The noising layer 340 may enhance high-frequency components by adding sinusoid-based noise (e.g., a periodic pattern) to the facial image.

The checkerboard-based noise addition transformation f₆ may be performed based on a parameter θ6 of the noising layer 340. For example, the noising layer 340 may add N×N (e.g., 4×4) checkerboard patterns to each block of a facial image. The N×N checkerboard patterns may be adjusted according to the parameter θ₆. The addition of the N×N checkerboard patterns may result in high-frequency components being added to the facial image.

The speckle-based noise addition transformation f₇ may be performed based on a parameter θ₇ of the noising layer 340. For example, the noising layer 340 may assign the parameter θ₇ to the center of each block of a facial image. The noising layer 340 may then determine pixel values of the remaining blocks by bilinear interpolation from the center of each block to which the parameter θ₇ is assigned.

The noising layer 340 may combine the facial images on which the sinusoid-based noise addition transformation f₅, the checkerboard-based noise addition transformation f₆, and the speckle-based noise addition transformation f₇ have been performed. For example, the noising layer 340 may normalize blocks of the input facial image on which the sinusoid-based noise addition transformation f₅, the checkerboard-based noise addition transformation f₆, and the speckle-based noise addition transformation f₇ have been performed, through a SoftMax operation. The noising layer 340 may combine the normalized blocks with the blocks of the image on which the warping transformation f₄ is performed by the warping layer 330 to generate a single overlapped block. The image on which the noise addition transformations are performed may include a plurality of overlapped blocks. Specifically, the noising layer 340 may combine the input facial images on which the sinusoid-based noise addition transformation f₅, the checkerboard-based noise addition transformation f₆, and the speckle-based noise addition transformation f₇ have been performed, through Equation 2 below.

$${\overline{ϕ}}_{6}^{{}_{c}} to {\overline{ϕ}}_{7}^{{}_{c}}$$

In Equation 2, B_{warped} denotes a block of an image on which the warping transformation is performed, B₅ denotes a block of an image on which the sinusoid-based noise addition transformation f₅ is performed, B₆ denotes a block of an image on which the checkerboard-based noise addition transformation f₆ is performed, B₇ denotes a block of an image on which the speckle-based noise addition transformation f₇ is performed,

$${\overline{ϕ}}_{5}^{c} to {\overline{ϕ}}_{7}^{c}$$

denote random parameters for a SoftMax operation of blocks with corresponding indices, Bₙₒᵢ denotes an overlapped block, and c denotes an RGB channel of an input facial image.

The scaling layer 350 may generate an output facial image by adjusting (hereinafter, referred to as a scaling transformation f₈) a color value of a facial image (e.g., the input facial image on which transformations are performed by the averaging layer 320, the warping layer 330, and the noising layer 340) to which noise is added. The scaling transformation f₈ may be a transformation that adjusts a color value (e.g., color intensity) of the facial image.

The scaling transformation f₈ may be performed based on a parameter θ₈ of the scaling layer 350. For example, the scaling transformation f₈ may adjust a color value of each block of a facial image using the parameter θ₈. When the parameter θ₈ is greater than 1, the brightness of a block may increase, and when the parameter θ₈ is less than 1, the brightness of a block may decrease. By adjusting the color intensity of an image, the scaling transformation f₈ may increase the obfuscation degree while increasing reconstructability (e.g., the reconstruction degree of the original facial image (e.g., the input facial image) from the transformed facial image (e.g., the output facial image)).

The feature extractor 230 may include a plurality of feature extractors 360 and 370. The feature extractor 360 may extract features from the output facial image Iₒᵤₜ. The feature extractor 370 may extract features from the input facial image Iᵢₙ. The configuration and operation of the feature extractors 360 and 370 may be substantially the same as those of the feature extractor 230, and a repeated description thereof will be omitted.

In the above description, a method of converting the input facial image Iᵢₙ through a plurality of layers included in the obfuscation module 210 to obtain (or generate) the output facial image Iₒᵤₜ has been described in detail. The conversion of the input facial image Iᵢₙ may be performed based on parameters (e.g., the parameters θ₁ to θ₈) of the plurality of layers included in the obfuscation module 210. In conclusion, the obfuscation degree and reconstructability of the output facial image Iₒᵤₜ may be determined by converting the input facial image Iᵢₙ based on an update (or training) of the parameters θ₁ to θ₈. Hereinafter, a method of training a neural network through a backpropagation refinement scheme will be described in detail to determine the parameters θ₁ to θ₈ that achieve a trade-off between the obfuscation degree and reconstructability (e.g., the degree of reconstructing identification information of an input facial image from an output facial image) of the output facial image Iₒᵤₜ.

First, the difference between the backpropagation refinement scheme and a conventional backpropagation method will be described. The conventional backpropagation method calculates a loss function by comparing an output generated through a forward propagation process with ground truth and updates the parameters of a neural network through a backpropagation process. However, the backpropagation refinement scheme may update parameters of a neural network by repeatedly performing forward and backpropagation processes, rather than calculating a loss function through comparison with ground truth. The forward propagation process may include operations (e.g., obtaining an output facial image based on an input facial image) performed by the obfuscation module 210 and operations (e.g., extracting features from an input facial image and extracting features from an output facial image) performed by the feature extractor 230. The backpropagation process may include updating the parameters of a neural network.

Hereinafter, a method of updating parameters of a neural network through the backpropagation refinement scheme according to the present disclosure will be described in detail.

The parameters (e.g., the parameters θ₁ to θ₈) of the obfuscation module 210 may control a transformation of an input facial image, and the quality of an output facial image may be determined based on an initialization method of these parameters.

The parameters may be classified into four categories according to their characteristics. The parameter initialization module 310 may perform initialization of the parameters in different categories using different initialization methods.

The parameters may include fixed parameters, uniform parameters, color parameters, and combining parameters according to their characteristics. Hereinafter, characteristics and initialization methods of each type of parameter will be described.

The fixed parameters may refer to parameters fixed to specific values. The fixed parameters may be used to remove high-frequency information (or details of a facial image) and thereby increase the obfuscation degree (or human indecipherability (HI)) of the facial image. The parameters θ₁ to θ₃ and θ₆ may be fixed parameters, as they are used to remove high-frequency information of the facial image. The parameters θ₁ to θ₃ and θ₆ may be fixed to specific values (e.g., 1). For example, when the mosaic transformation f₁ is performed based on the parameter θ₁ (e.g., 1), all pixels of each block may be adjusted to the same average value and thereby removing high-frequency information of the input facial image. Because the fixed parameters are always fixed to predetermined values, no separate initialization may be required by the parameter initialization module 310.

The uniform parameters may refer to parameters having values uniformly distributed within a specific range. The parameters θ₄, θ₅, and θ₇ may be uniform parameters.

The parameter initialization module 310 may set values of the parameters θ₄, θ₅, and θ₇ such that they have values

$$( e . g . , \frac{1}{{θ}_{max} - {θ}_{min}} )$$

uniformly distributed within a specific range (e.g., from θₘᵢₙ to θₘₐₓ). For example, in the warping transformation f₄, the parameter initialization module 310 may set a movement range of grid points according to the parameter θ₄ to [−0.3, 0.3]. The parameter initialization module 310 may set an initial value of the parameter θ₄ (e.g., 10/6). As the grid points move based on values (e.g., 10/6) uniformly distributed in the range of [−0.3, 0.3], sufficient distortion may be caused in the facial image without causing excessive deformation of the grid. Since the sinusoid-based noise addition transformation f₅ and the speckle-based noise addition transformation f₇ are initialized in a manner similar to the warping transformation f₄, a repeated description thereof will be omitted.

The color parameters refer to parameters that control color transformation and may be used to adjust the color of an input facial image. Since the parameter θ₈ is used to adjust the color intensity of an image, it may be a color parameter. When the parameter θ₈ is greater than 1, the brightness of the input facial image may increase, and when the parameter θ₈ is less than 1, the brightness of the input facial image may decrease.

The parameter initialization module 310 may set a value of the parameter θ₈ by determining brightness increase or decrease with an equal probability (e.g., 50%). The parameter initialization module 310 may initialize the parameter θ₈ within a specific range (e.g., from

$$\frac{1}{{θ}_{min}} to {θ}_{max} ) .$$

Through this, the color transformation may enable obfuscation of the image while preserving high-frequency information of the image.

The combining parameters may refer to parameters used to combine the results of multiple transformations. The combining parameters may be used to combine transformed image blocks. The combining parameters may include random parameters (e.g.,

$${\overline{ϕ}}_{1}^{c} to {\overline{ϕ}}_{3}^{c}$$

### in Equation 1 and

$${\overline{ϕ}}_{5}^{c} to {\overline{ϕ}}_{7}^{c}$$

in Equation 2) for a SoftMax operation. For example, the combining parameters may be normalized through a SoftMax operation such that a ratio of the combined blocks may be appropriately adjusted.

The parameter initialization module 310 may uniformly initialize the combining parameters within a specific range (e.g., from 0 to 1).

The parameters of a neural network (e.g., the obfuscation module 210), initialized through the parameter initialization module 310, may be trained through the backpropagation refinement scheme described below and thus be determined as values at which a trade-off is achieved between the obfuscation degree of an output facial image and the degree to which identity information included in an input facial image is reconstructed from the output facial image. Hereinafter, a method of updating (or optimizing) the initialized parameters will be described in detail.

The obfuscation module 210 may convert an input facial image Iᵢₙ into an output facial image Iₒᵤₜ based on initial values of parameters (e.g., parameters θ₁ to θ₈ and combining parameters (e.g.,

$${\overline{ϕ}}_{1}^{c} to {\overline{ϕ}}_{3}^{c}$$

### of Equation 1 and

$${\overline{ϕ}}_{5}^{c} to {\overline{ϕ}}_{7}^{c}$$

of Equation 2)) of a plurality of layers (e.g., the averaging layer 320, the warping layer 330, the noising layer 340, and the scaling layer 350), which may be set by the parameter initialization module 310. Even if the output facial image Iₒᵤₜ generated based on the initial values of the parameters has a high obfuscation degree, its reconstructability (e.g., the degree to which identity information of the input facial image Iᵢₙ is reconstructed from the output facial image Iₒᵤₜ) may be low. For example, features of the output facial image Iₒᵤₜ (e.g., extracted by the feature extractor 360) may be significantly different from features of the input facial image Iᵢₙ (e.g., extracted by the feature extractor 370).

The parameters of the obfuscation module 210 may be trained using four loss functions.

The fixed parameters (e.g., parameters θ₁ to θ₃ and θ₆) may not be subject to updates since they are fixed to predetermined values.

The electronic device 100 may change parameters of a neural network such that the parameters do not exceed a predetermined threshold (e.g., a margin). Specifically, the uniform parameters and the color parameters may be trained by the electronic device 100 as described below.

The uniform parameters (e.g., parameters θ₄, θ₅, and θ₇) may be trained using a first loss function. The first loss function may update the uniform parameters in a manner that increases the obfuscation degree. The first loss function may be expressed by Equation 3 below.

$${ℰ}_{U} = {\sum }_{{θ}_{i} ∈ {⊖}_{i} ⊂ {⊖}_{U}} max \{ {λ}_{i} - \vert {θ}_{i} \vert , 0 \} \qquad [ Equation 3 ]$$

In equation 3, θᵢ denotes a uniform parameter and λᵢ denotes a margin set for a parameter θᵢ (e.g., 0.05 for the parameter θ₄, 0 for the parameter θ₅, and 0.1 for the parameter θ₇).

The first loss function may be configured such that the closer a uniform parameter is to the margin, the greater the obfuscation degree becomes.

A color parameter (e.g., the parameter θ₈) may be trained through a second loss function. The second loss function may update the color parameter in a manner that increases the obfuscation degree. The second loss function may be expressed by Equation 4 below.

$${ℰ}_{U} = {\sum }_{{θ}_{i} ∈ {Θ}_{i} ⊂ {Θ}_{U}} max \{ [ {θ}_{i} > 1 ] ( {λ}_{i} - {θ}_{i} ) , [ {θ}_{i} < 1 ] ( {θ}_{i} - \frac{1}{{λ}_{i}} ) \} \qquad [ Equation 4 ]$$

In Equation 4, [ ] denotes an indicator function, θᵢ denotes a color parameter, and λᵢ denotes a margin (e.g., 1.05 for the parameter θ₈) set for the parameter θᵢ.

The second loss function may determine the direction in which the color parameter is to be optimized, either to increase or decrease brightness.

To improve the reconstructability (e.g., a degree to which identification information included in an input facial image is reconstructed from an output facial image) of the output facial image, parameters (e.g., the parameters θ₁ to θ₈ or combined parameters (e.g.,

$${\overline{ϕ}}_{1}^{c} to {\overline{ϕ}}_{3}^{c}$$

### in Equation 1 and

$${\overline{ϕ}}_{5}^{c} to {\overline{ϕ}}_{7}^{c}$$

in Equation 2)) of the neural network may be trained in Equation 1 and through a third loss function and a fourth loss function.

The electronic device 100 may calculate a distance (e.g., a Euclidean distance) between features of an input facial image and an output facial image. The electronic device 100 may calculate the third loss function based on the Euclidean distance. The third loss function may be configured to minimize the Euclidean distance between a feature of the input facial image Iᵢₙ and a feature of the output facial image Iₒᵤₜ. The electronic device 100 may update parameters of the neural network to minimize the distance. Specifically, the third loss function may be expressed by Equation 5 below.

$${ℰ}_{D} = {‖ ℱ ( {I}_{out} ( Θ ) ) - ℱ ( {I}_{in} ) ‖}_{2} . \qquad [ Equation 5 ]$$

In Equation 5, [symbol] (Iₒᵤₜ(θ) denotes a feature of the output facial image Iₒᵤₜ, and [symbol] (Iᵢₙ) denotes a feature of the input facial image Iᵢₙ.

The electronic device 100 may calculate a cosine similarity between features of an input facial image and an output facial image. Based on this cosine similarity, the electronic device 100 may calculate the fourth loss function. The fourth loss function may be configured to maximize the cosine similarity between a feature of the input facial image Iᵢₙ and a feature of the output facial image Iₒᵤₜ. The electronic device 100 may update parameters of the neural network to maximize the cosine similarity. Specifically, the fourth loss function may be expressed by Equation 6 below.

$${ℰ}_{S} = 1 - \frac{{ℱ ( {I}_{out} ( Θ ) )}^{T} ℱ ( {I}_{in} )}{‖ {ℱ ( {I}_{out} ( Θ ) )}^{T} ‖ ‖ ℱ ( {I}_{in} ) ‖} \qquad [ Equation 6 ]$$

In Equation 6, [symbol] (Iₒᵤₜ(θ) denotes a feature of the output facial image Iₒᵤₜ, and [symbol] (Iᵢₙ) denotes a feature of the input facial image Iᵢₙ.

Accordingly, the first to fourth loss functions may be trained in an end-to-end manner through a loss function in Equation 7 below.

$$E ( Θ ) = {E}_{U} + {E}_{C} + {E}_{D} + {E}_{S} \qquad [ Equation 7 ]$$

Equation 7 may define a loss function that is a weighted sum of the first to fourth loss functions, configured to find optimal parameters that balance the obfuscation degree and the reconstructability.

The parameters may be trained through a backpropagation process such that a loss function obtained through a forward propagation process is optimized. Specifically, the electronic device 100 may calculate derivatives of the loss function and compute a gradient for each parameter. The derivatives of the loss function may be expressed by Equations 8 to 10, respectively.

$$\frac{\partial {ℰ}_{U}}{\partial {θ}_{i}} = \{ \begin{matrix}- 1 & if 0 < {θ}_{i} < {λ}_{i} , \\ 1 & if - {λ}_{i} < {θ}_{i} < 0 , \\ 0 & otherwise .\end{matrix} \qquad [ Equation 8 ]$$

$$\frac{\partial {ℰ}_{C}}{\partial {θ}_{i}} = \{ \begin{matrix}- 1 & if 1 < {θ}_{i} < {λ}_{i} , \\ 1 & if \frac{1}{{λ}_{i}} < {θ}_{i} < 1 , \\ 0 & otherwise .\end{matrix} \qquad [ Equation 9 ]$$

$$\frac{\partial ℰ}{\partial Θ} = \frac{\partial {ℰ}_{U}}{\partial Θ} + \frac{\partial {ℰ}_{C}}{\partial Θ} + \frac{\partial {ℰ}_{D}}{\partial Θ} + \frac{\partial {ℰ}_{S}}{\partial Θ} \qquad [ Equation 10 ]$$

The parameters in Equations 8 to 10 correspond to those defined in Equations 1 to 7.

The electronic device 100 may update parameters based on gradients. This process (e.g., calculating a loss function through a forward propagation process, calculating derivatives of the loss function through a backpropagation process, and updating parameters accordingly) may be repeatedly performed until convergence. Through this process, parameters of a neural network (e.g., the obfuscation module 210) may be determined such that a trade-off is achieved between the obfuscation degree and the reconstructability (e.g., the degree to which identification information is reconstructed from an output facial image) of the output facial image.

Training through the backpropagation refinement scheme may allow the output facial image to remain recognizable by a machine learning algorithm even after the parameters are initialized, while simultaneously making it difficult for a human to recognize the output facial image.

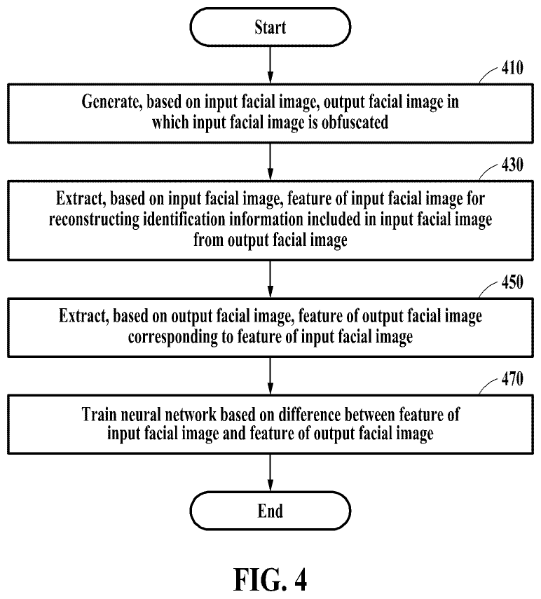

FIG. 4 illustrates an example flowchart of a method of training a neural network according to an embodiment.

Referring to FIG. 4, operations 410 to 470 may be performed sequentially but are not limited thereto. For example, two or more operations may be performed in parallel. Operations 410 to 470 may be substantially the same as the operations of the electronic device (e.g., the electronic device 100 of FIG. 1) described with reference to FIGS. 1 to 3. Accordingly, a detailed description thereof will be omitted.

In operation 410, the electronic device 100 may obtain, based on an input facial image, an output facial image in which the input facial image is obfuscated.

In operation 430, the electronic device 100 may extract, based on the input facial image, a feature of the input facial image for reconstructing identification information included in the input facial image from the output facial image.

In operation 450, the electronic device 100 may extract, based on the output facial image, a feature of the output facial image corresponding to the feature of the input facial image.

In operation 470, the electronic device 100 may train the neural network based on a difference between the feature of the input facial image and the feature of the output facial image.

The examples described herein may be implemented using hardware components, software components and/or combinations thereof. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

Software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of training a neural network configured to obfuscate a facial image, the method comprising:
obtaining, based on an input facial image, an output facial image in which the input facial image is obfuscated;
extracting, based on the input facial image, a feature of the input facial image for reconstructing identification information included in the input facial image from the output facial image;
extracting, based on the output facial image, a feature of the output facial image corresponding to the feature of the input facial image; and
training the neural network based on a difference between the feature of the input facial image and the feature of the output facial image.

2. The method of claim 1, wherein the obtaining of the output facial image comprises generating the output facial image by inputting the input facial image to the neural network.

3. The method of claim 2, wherein the generating of the output facial image comprises:
performing an averaging transformation on the input facial image;
rearranging pixels of the input facial image, on which the averaging transformation has been performed, by warping the input facial image on which the averaging transformation has been performed;
adding noise to the input facial image whose pixels have been rearranged; and
generating the output facial image by adjusting a color value of the input facial image to which the noise has been added.

4. The method of claim 3, wherein the averaging transformation comprises a mosaic transformation and a transformation that adjusts pixels along one axis of an image to an average value of the pixels.

5. The method of claim 3, wherein the noise comprises sinusoid-based noise, checkerboard-based noise, and speckle-based noise.

6. The method of claim 2, wherein the training of the neural network comprises:
updating parameters of the neural network through a backpropagation refinement scheme, based on a difference between the feature of the input facial image and the feature of the output facial image,
wherein the parameters of the neural network relate to obfuscating the input facial image.

7. The method of claim 6, wherein the backpropagation refinement scheme comprises:
repeatedly performing a forward propagation process and a backpropagation process to determine the parameters of the neural network, such that a trade-off is achieved between an obfuscation degree of the output facial image and a reconstruction degree of the identification information from the output facial image,
wherein the forward propagation process comprises obtaining the output facial image, extracting the feature of the input facial image, and extracting the feature of the output facial image, and
the backpropagation process comprises updating the parameters of the neural network.

8. The method of claim 7, wherein the updating of the parameters of the neural network comprises:
calculating a distance between the feature of the input facial image and the feature of the output facial image; and
changing the parameters of the neural network such that the distance is minimized.

9. The method of claim 7, wherein the updating of the parameters of the neural network comprises:
calculating a cosine similarity between the feature of the input facial image and the feature of the output facial image; and
changing the parameters of the neural network such that the cosine similarity is maximized.

10. The method of claim 7, wherein the updating of the parameters of the neural network comprises changing the parameters of the neural network such that the parameters of the neural network do not exceed a preset threshold value.

11. An electronic device for obfuscating a facial image, the electronic device comprising:
a processor; and
memory storing instructions,
wherein the instructions, when executed by the processor, cause the electronic device to obtain, based on an input facial image, an output facial image in which the input facial image is obfuscated through a neural network,
wherein the neural network is trained by a method according to any one of claim 1.

12. An electronic device for training a neural network configured to obfuscate a facial image, the electronic device comprising:
a processor; and
memory storing instructions,
wherein the instructions, when executed by the processor, cause the electronic device to:
obtain, based on an input facial image, an output facial image in which the input facial image is obfuscated;
extract, based on the input facial image, a feature of the input facial image for reconstructing identification information included in the input facial image from the output facial image;
extract, based on the output facial image, a feature of the output facial image corresponding to the feature of the input facial image; and
train the neural network based on a difference between the feature of the input facial image and the feature of the output facial image.

13. The electronic device of claim 12, wherein the instructions, when executed by the processor, cause the electronic device to generate the output facial image by inputting the input facial image to the neural network.

14. The electronic device of claim 13, wherein the instructions, when executed by the processor, cause the electronic device to:
perform an averaging transformation on the input facial image;
rearrange pixels of the input facial image, on which the averaging transformation has been performed, by warping the input facial image on which the averaging transformation has been performed;
add noise to the input facial image whose pixels have been rearranged; and
generate the output facial image by adjusting a color value of the input facial image to which the noise has been added.

15. The electronic device of claim 14, wherein the averaging transformation comprises a mosaic transformation and a transformation that adjusts pixels along one axis of an image to an average value of the pixels.

16. The electronic device of claim 13, wherein the instructions, when executed by the processor, cause the electronic device to:
update parameters of the neural network through a backpropagation refinement scheme, based on a difference between the feature of the input facial image and the feature of the output facial image,
wherein the parameters of the neural network relate to obfuscating the input facial image.

17. The electronic device of claim 16, wherein the backpropagation refinement scheme comprises:
repeatedly performing a forward propagation process and a backpropagation process to determine the parameters of the neural network, such that a trade-off is achieved between an obfuscation degree of the output facial image and a reconstruction degree of the identification information from the output facial image,
wherein the forward propagation process comprises obtaining the output facial image, extracting the feature of the input facial image, and extracting the feature of the output facial image, and
the backpropagation process comprises updating the parameters of the neural network.

18. The electronic device of claim 17, wherein the instructions, when executed by the processor, cause the electronic device to:
calculate a distance between the feature of the input facial image and the feature of the output facial image; and
change the parameters of the neural network such that the distance is minimized.

19. The electronic device of claim 17, wherein the instructions, when executed by the processor, cause the electronic device to:
calculate a cosine similarity between the feature of the input facial image and the feature of the output facial image; and
change the parameters of the neural network such that the cosine similarity is maximized.

20. The electronic device of claim 17, wherein the instructions, when executed by the processor, cause the electronic device to change the parameters of the neural network such that the parameters of the neural network do not exceed a preset threshold value.
